(19) United States
(12) Patent Application Publication
(10) Pub. No.: US 2026/0084768 A1
(43) Pub. Date: Mar. 26, 2026

(54) WALL-MOUNTED BICYCLE RACK

(71) Applicant: Bike Genie, LLC, St. George, UT (US)

(72) Inventors: Eugene H. Jones, St. George, UT (US); Jonathan M. Cole, St. George, UT (US)

(73) Assignee: Bike Genie, LLC, St. George, UT (US)

(21) Appl. No.: 19/338,300

(22) Filed: Sep. 24, 2025

Related U.S. Application Data
(60) Provisional application No. 63/698,478, filed on Sep. 24, 2024.
(60) Provisional application No. 63/742,785, filed on Jan. 7, 2025.

(51) Int. Cl. B62H 3/12; B62H 5/00; F16M 13/02

(52) U.S. Cl. CPC B62H 3/12; B62H 5/005; F16M 13/022; F16M 2200/021; F16M 2200/044

(57) ABSTRACT

A bicycle rack includes a wall bracket, a pivotable member coupled to the wall bracket and configured to pivot on an x-axis, the pivotable member having a first tire member and having a hydraulic damper (or other shock absorber/linear actuator) interposed between the first tire member and a cam pin, an arm pivotably coupled to the pivotable member, the arm configured to pivot on a y-axis, a gas spring (or other spring) interposed between the arm and pivotable member and configured to provide the force needed to maintain the position of the bicycle on the bike rack, the arm further including a hook coupled at the distal end for securing a tire of a bicycle. The gas spring aids the user in easily raising and lowering the bicycle to a desired storage height, which may be above the head.

### CROSS-REFERENCE TO RELATED APPLICATIONS

This application claims the benefit of U.S. Provisional Application Ser. No. 63/742,785, filed on Jan. 7, 2025, and claims the benefit of U.S. Provisional Application Ser. No. 63/698,478, filed on Sep. 24, 2024, both of which are incorporated herein by reference.

### TECHNICAL FIELD

The present disclosure relates to bicycle racks. More particularly, the present disclosure relates to wall-mounted bicycle racks.

### BACKGROUND

Bicycles, when not in use, can occupy valuable storage space and pose significant challenges in maintaining an organized and accessible storage area. This issue is particularly pronounced in residential settings such as garages, where space is often shared with vehicles, tools, and other household items. The need to store bicycles in a manner that preserves space and prevents damage is critical, especially given the high cost of many bicycles and the potential for damage if they are knocked over or improperly stored.

Traditional methods of bicycle storage include the use of brackets, pulleys, and bulky metal frames, which allow bicycles to be stored vertically on a wall, side-by-side, or hung from the ceiling. While these solutions can free up space, they come with their own set of problems. Wall mounts, for instance, though effective in clearing floor space, can still encroach on walking space, making it difficult to navigate the garage. If these mounts are positioned high enough to avoid impeding movement, they can become difficult to use without the aid of a step ladder, and can be dangerous regardless.

Ceiling mounts present similar challenges. Users often struggle with the physical effort and balance required to hang and remove bicycles from overhead hooks. Additionally, many ceiling and wall mounts rely on suspending the bicycle by its front wheel, which can lead to instability. The bicycle tends to flop from side-to-side during the mounting and removal process, increasing the risk of accidents or damage to the bicycle and surrounding items.

Given these issues, there is a clear need for a bicycle storage solution that not only maximizes space efficiency, but also ensures ease of access and stability. An ideal solution would accommodate various storage space restrictions, provide multiple directions and positions for storing bicycles, and be safe and user-friendly. This would significantly enhance the usability of storage areas, particularly in environments where space is at a premium and safety is a concern. The present disclosure seeks to solve these and other problems.

### SUMMARY OF EXAMPLE EMBODIMENTS

In some embodiments, a wall-mounted bicycle rack may comprise a wall bracket, a pivotable member coupled to the wall bracket and configured to pivot on an x-axis (i.e., horizontally), and an arm pivotably coupled to the pivotable member. The pivotable member may be configured out of a first plate and a second plate coupled to each other via fasteners. A first block and a second block may be interposed between the first and second plates. The first and second blocks may house a cam pin and a bushing, or the first and/or second plates may be configured to function as a cam mechanism. The pivotable member may comprise a first tire member descending downward therefrom. The first tire member may include a first pad that is configured to receive either a front tire or rear tire on a bicycle. A hydraulic damper may be coupled to and interposed between the first tire member and the cam pin.

The arm may be pivotably coupled to the pivotable member via a pin. The arm may comprise a first arm panel and a second arm panel. The arm may be configured to pivot on a y-axis and configured to receive a gas spring, or any other type of spring or hydraulic mechanism, that is interposed between the arm and pivotable member and configured to assist in lifting the bicycle and holding it in the second position. The gas spring may be mounted in such a way that it applies both upward and downward force to the arm along its travel as it passes center neutral between its mounting points and the pivot point of the arm. The bike rack may swing/pivot up and down between the first position and the second position. When in the first position, the arm may be at an angle below a horizontal plane at the center of the second pin. When in the second position, the arm may be vertical and parallel to the wall. The arm may further comprise a handle and a second pad (similar to the first pad) that may receive the front or rear tire of the bicycle. The arm further comprises a hook coupled at the distal end for securing the front or rear tire of the bicycle.

In some embodiments, the bike rack comprises a spring-loaded locking pin configured to secure the pivotable member in a desired configuration in relation to the wall bracket. In some embodiments, a plate and detent may be used to selectively position the pivotable member.

In some embodiments, the wall bracket is configured to couple to one or more E-track rails, which are coupled to the wall.

In some embodiments, the bike rack comprises a lock, wherein the lock passes through the wall bracket to thereby prevent access to the bottom lag screw holding it to the wall and thereby preventing unwanted removal of the bike rack from the wall.

In one method of use, with the bike rack mounted to a wall (or other surfaces), the user will place the arm in a first position, rotate the hook to an outward position to receive the tire (e.g., placing the bike in a wheelie so as to easily balance the bicycle while a tire is received in the hook), with the tire hooked, the user pulls backwards on the bicycle, which causes the arm to begin to raise vertically. Once the arm reaches a vertical threshold, the gas spring begins to force the arm upward, assisting the user with lifting the bicycle. Once the bicycle is fully lifted, each tire rests on the first and second pads and the gas spring holds the bicycle in place in the second position. As long as the user can grasp the tire positioned against the second pad (or any other portion of the bicycle), the bicycle may be retrieved by simply pulling it downwardly and outwardly. The user can then remove the hook from the tire and bring the bicycle to rest on the floor. The bike rack can stay in the downward position until the bicycle needs to be stored again. In some embodiments, the bike rack can be pivoted parallel to the wall and out of the way. As a result, the bicycle can be quickly and easily stored above shoulder and head height, freeing up space, without the need for step stools or ladders.

### BRIEF DESCRIPTION OF THE DRAWINGS

FIG. 1 illustrates a side perspective view of a wall-mounted bicycle rack in a first position;

FIG. 2 illustrates a side perspective view of a wall-mounted bicycle rack in a second position;

FIG. 3 illustrates a bottom, side perspective view of a wall-mounted bicycle rack in a first position;

FIG. 4 illustrates a detailed view of portions of a wall-mounted bicycle rack shown in circle 4 of FIG. 3;

FIG. 5 illustrates a side perspective view of two wall-mounted bicycle racks in a first position;

FIG. 6 illustrates a side perspective view of a wall-mounted bicycle rack in a second position;

FIG. 7 illustrates a detailed view of portions of a wall-mounted bicycle rack shown in circle 7 of FIG. 6;

FIG. 8 illustrates a side elevation view of a wall-mounted bicycle rack in a first position with a bicycle coupled thereto;

FIG. 9 illustrates a side elevation view of a wall-mounted bicycle rack in a second position with a bicycle coupled thereto;

FIG. 10 illustrates a side perspective view of a wall-mounted bicycle rack in a second position;

FIG. 11 illustrates a detailed perspective view of portions of the wall-mounted bicycle rack shown in circle 11 of FIG. 10.

FIG. 12 illustrates a side perspective view of a wall-mounted bicycle rack between a first and second position;

FIG. 13 illustrates a detailed perspective view of portions of the wall-mounted bicycle rack shown in circle 13 of FIG. 12; and

FIG. 14 illustrates a detailed perspective view of portions of the wall-mounted bicycle rack shown in circle 14 of FIG. 12.

### DETAILED DESCRIPTION OF EXAMPLE EMBODIMENTS

The following descriptions depict only example embodiments and are not to be considered limiting in scope. Any reference herein to “the invention” is not intended to restrict or limit the invention to exact features or steps of any one or more of the exemplary embodiments disclosed in the present specification. References to “one embodiment,” “an embodiment,” “various embodiments,” and the like, may indicate that the embodiment(s) so described may include a particular feature, structure, or characteristic, but not every embodiment necessarily includes the particular feature, structure, or characteristic. Further, repeated use of the phrase “in one embodiment,” or “in an embodiment,” do not necessarily refer to the same embodiment, although they may.

Reference to the drawings is done throughout the disclosure using various numbers. The numbers used are for the convenience of the drafter only and the absence of numbers in an apparent sequence should not be considered limiting and does not imply that additional parts of that particular embodiment exist. Numbering patterns from one embodiment to the other need not imply that each embodiment has similar parts, although it may.

Accordingly, the particular arrangements disclosed are meant to be illustrative only and not limiting as to the scope of the invention, which is to be given the full breadth of the appended claims and any and all equivalents thereof. Although specific terms are employed herein, they are used in a generic and descriptive sense only and not for purposes of limitation. Unless otherwise expressly defined herein, such terms are intended to be given their broad, ordinary, and customary meaning not inconsistent with that applicable in the relevant industry and without restriction to any specific embodiment hereinafter described. As used herein, the article “a” is intended to include one or more items. When used herein to join a list of items, the term “or” denotes at least one of the items, but does not exclude a plurality of items of the list. For exemplary methods or processes, the sequence and/or arrangement of steps described herein are illustrative and not restrictive.

It should be understood that the steps of any such processes or methods are not limited to being carried out in any particular sequence, arrangement, or with any particular graphics or interface. Indeed, the steps of the disclosed processes or methods generally may be carried out in various sequences and arrangements while still falling within the scope of the present invention.

The term “coupled” may mean that two or more elements are in direct physical contact. However, “coupled” may also mean that two or more elements are not in direct contact with each other, but yet still cooperate or interact with each other.

The terms “comprising,” “including,” “having,” and the like, as used with respect to embodiments, are synonymous, and are generally intended as “open” terms (e.g., the term “including” should be interpreted as “including, but not limited to,” the term “having” should be interpreted as “having at least,” the term “includes” should be interpreted as “includes, but is not limited to,”etc.).

As previously discussed, there is a need for a bicycle storage solution that not only maximizes space efficiency, but also ensures ease of access and stability. An ideal solution would accommodate various storage space restrictions, provide multiple directions and positions for storing bicycles, and be safe and user-friendly. This would significantly enhance the usability of storage areas, particularly in environments where space is at a premium and safety is a concern. The bicycle rack disclosed herein solves these and other problems.

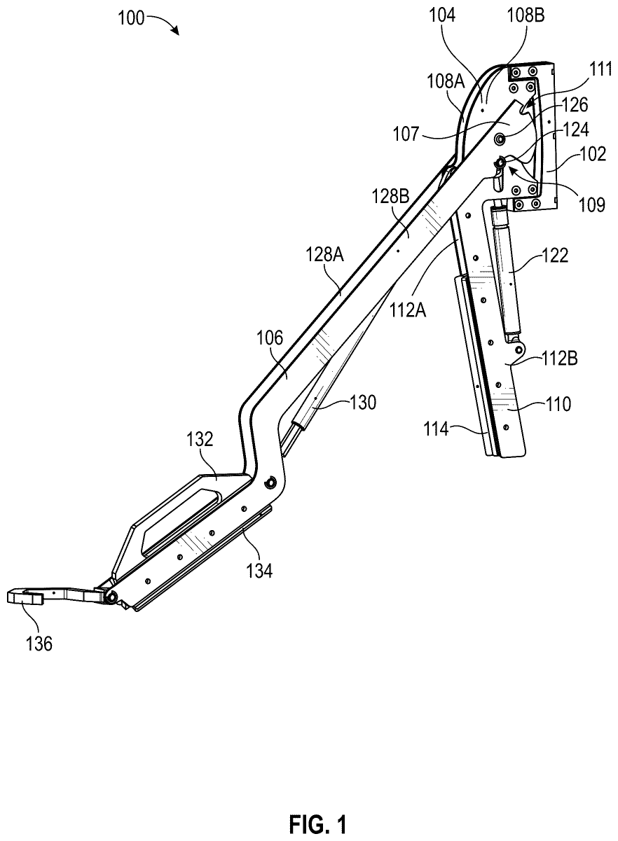

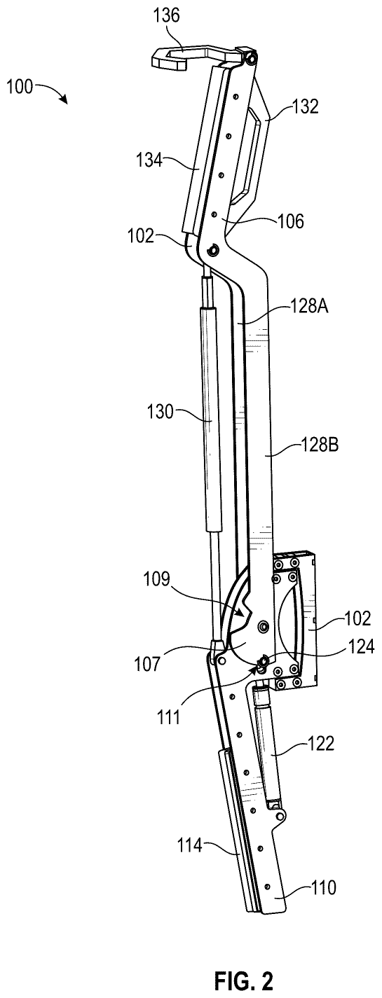

FIGS. 1-2 illustrate a wall-mounted bicycle rack 100 (hereinafter referred to as the “bike rack”) in a first, bicycle attaching position and a second, bicycle storage position, respectively. The bike rack 100 is configured to easily allow a user to mount and store a bicycle vertically on a wall above shoulder height, or any other height. Further, the bike rack 100 allows the bicycle to be moved up and down from the first position to the second position and vice versa without difficulty and also allows the bicycle to swing right or left on an x-axis (i.e., horizontally) to a narrow angle near to the wall, thereby maximizing the use of the storage space. The bike rack 100 may comprise a wall bracket 102, a pivotable member 104 coupled to the wall bracket 102 and configured to pivot on an x-axis (i.e., horizontally), and an arm 106 pivotably coupled to the pivotable member 104 to pivot on a y-axis (i.e., vertically). The pivotable member 104 may be pivotably coupled to the wall bracket via one or more coupling pins 105 (FIG. 4) on a top end and a bottom end.

The pivotable member 104 may be configured out of a first plate 108A and a second plate 108B coupled to each other via fasteners. In some embodiments, the pivotable member 104 may be manufactured to be a single unit. The first and second plates 108A, 108B may be manufactured out of steel, aluminum, plastic, or any other type of material that is sufficiently rigid and durable to support a bicycle. A first block and a second block may be interposed between the first and second plates 108A, 108B. The first and second blocks may house a cam pin and a bushing. The first and second blocks may be manufactured out of aluminum, steel, plastic, or any other material commonly used in the art.

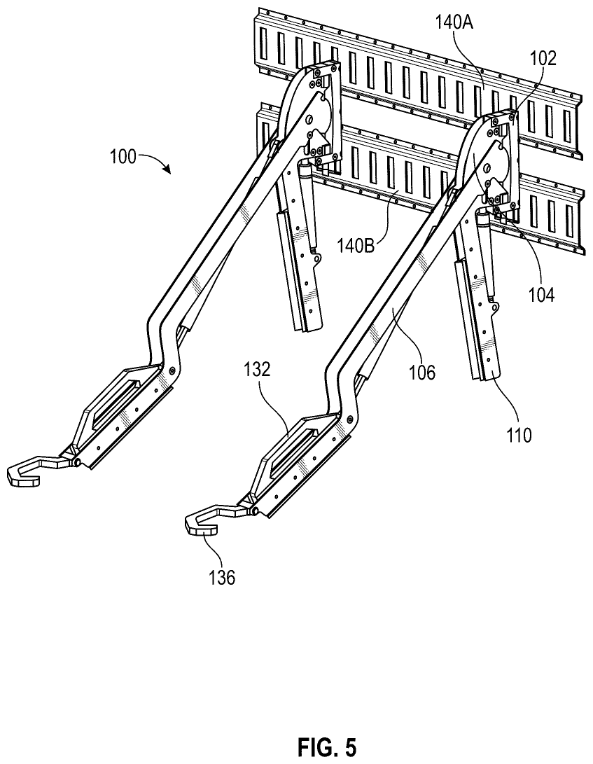

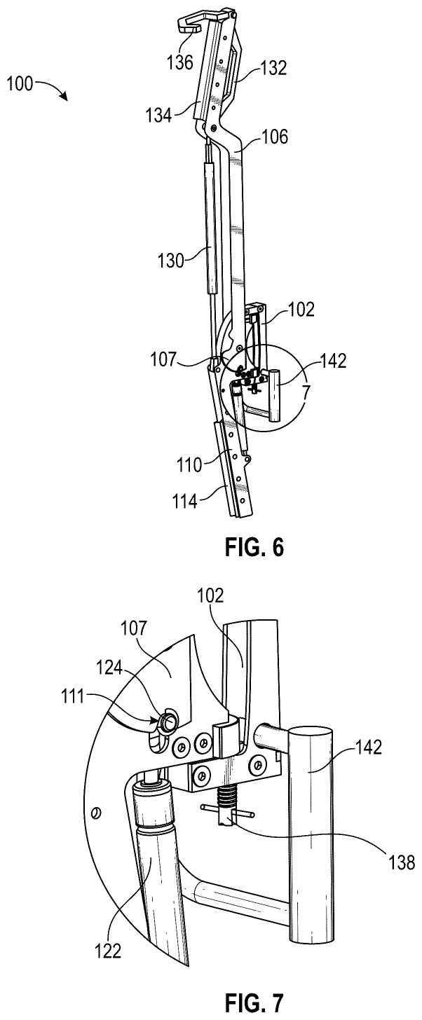

The pivotable member 104 may extend to, or otherwise comprise, a first tire member 110 extending therefrom. The first tire member 110 may comprise a first tire member plate 112A and a second tire member plate 112B. As shown, the first tire member plate 112A and the first plate 108A may be of single manufacture, and the second tire member plate 112B and the second plate 108B may be of single manufacture. However, in some embodiments, they may be multiple components coupled together. The first tire member 110 may include a first pad 114 that is configured to receive either a front tire 116 or rear tire 118 on a bike 120 (FIGS. 5-6) when the bike rack 100 is in the second position (best seen in FIG. 9). The first pad 114 may be comprised of foam, rubber, carpet, or any other type of padding material. However, it will be appreciated that the first pad 114 is not required and may simply be a surface, such as a plate (e.g., metal, plastic, carbon fiber, wood, etc.) with or without a non-slip surface.

A hydraulic damper 122 may be coupled to, and interposed between, the first tire member 110 and the cam pin 124 that passes through the first and second plates 108A-B (and may be housed in the first and second blocks therebetween). It will be appreciated that while a hydraulic damper 122 is discussed, a shock absorber/linear actuator, or any other shock-absorbing device may be used. Further, in some embodiments, the cam pin 124 and arm 106 may further comprise a cam configuration, or other mechanism coupled to the hydraulic damper 122, to compress the hydraulic damper 122 sufficiently to decrease and/or control the rate of speed of the arm 106 when vertically pivoting. While the damper 122 is shown and described, it is appreciated that it is not required and other configurations may be used, as will be discussed later herein.

For example, as best seen in FIG. 1, in some embodiments, the arm 106 may have a head 107 with a first notch 109 and a second notch 111 with riding surface therebetween, effectively creating a cam mechanism. In other words, as the arm 106 pivots vertically, the head 107 rides against the cam pin 124 which is coupled to a rod end of the hydraulic damper 122. As such, the head 107 functions as the cam, compressing the hydraulic damper 122 through its range of motion so as to decrease and/or control the rate of speed of the arm 106, thereby acting as a speed limiter. The cam pin 124 may rest in the first notch 109 when the arm is in a down, first position, and may mate with second notch 111 when the arm 106 is in an upright, second position. The hydraulic damper 122 is pressurized, causing it to return to its extended state as the arm 106 is moving in a downward motion when the bike 120 is being retrieved from its stored position/second position.

The arm 106 may be pivotably coupled to the pivotable member 104 via a second pin 126. The arm 106 may comprise a first arm panel 128A and a second arm panel 128B. However, in some embodiments, the arm 106 may be manufactured as a single unit. The arm 106 may be configured to pivot on a y-axis (i.e., vertically) and configured to receive a gas spring 130, or any other type of spring or hydraulic mechanism, that is interposed between, and couples, the arm 106 and pivotable member 104 (best seen in FIG. 2). The gas spring 130 is configured to assist in lifting the arm 106 and any bike 120 thereon, and helping it to remain in the second position (FIG. 2) when the cam pin 124 is in second notch 111.

The gas spring 130 may be mounted in such a way that it applies both upward and downward force to the arm 106 along its travel as it passes center neutral between its mounting points and the pivot point of the arm 106. In other words, the arm 106 may swing/pivot up and down between the first position (FIG. 1) and the second position (FIG. 2). That is, the arm 106 may move up or down to put the bike rack 100 in the first position (FIG. 1) or the second position (FIG. 2). When in the first position, the arm 106 may be at an angle below a horizontal plane at the center of the second pin 126, with the cam pin 124 in the first notch 109. When in the second position, the arm 106 may be raised above the horizontal plane at the center of the second pin 126, and parallel or substantially parallel to the wall in an upright position, with the cam pin 124 in the second notch 111.

The arm 106 may further comprise a handle 132 at a first end distal to the pivotable member 104 on a first side, and a second pad 134 (similar to the first pad 114) at the first end on a second, opposite side of the handle 132, the second pad 134 may receive the front or rear tire 116, 118 of the bike 120. The arm 106 further comprises a hook 136 extending from its distal end for securing the front or rear tire 116, 118 of the bike 120. In some embodiments, the hook 136 may be interchangeable with other shapes and sizes of hooks to receive different tires. While the hook 136 is shown and described, in some embodiments, straps, cords, chains, or any other securement mechanism may be used.

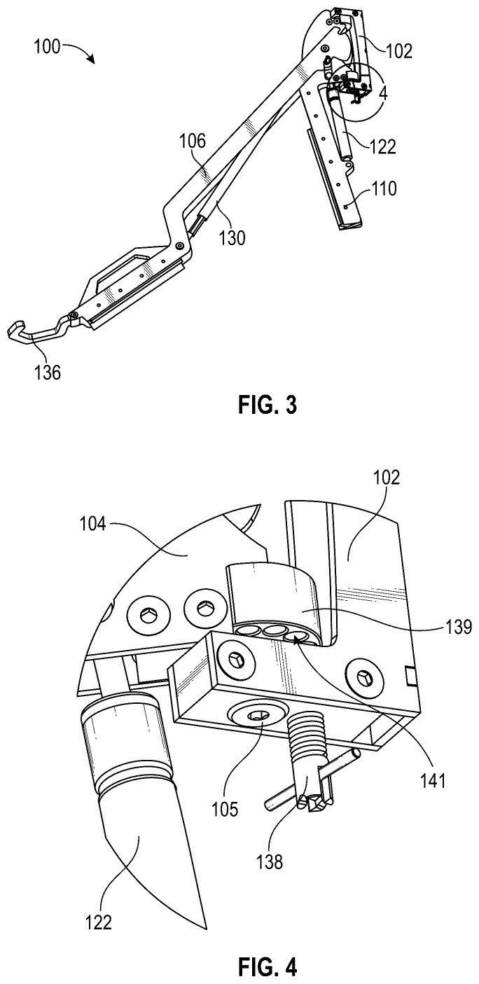

As shown in FIGS. 3-4, in some embodiments, the bike rack 100 comprises a spring-loaded locking pin 138 (e.g., an extension spring configuration) configured to secure the pivotable member 104 in a desired horizontal position in relation to the wall bracket 102. The spring-loaded locking pin 138 allows a user to adjust the angle of the pivotable member 104, and therefore the arm 106 and a bike secured thereon, in relation to the wall bracket 102 so as to maximize storage space. For example, as shown, the pivotable member 104 may comprise a hub 139 that may be at least partially semi-circular so as to facilitate pivoting, with a plurality of pin receiving apertures 141 on a bottom of the hub 139. As appreciated, a user may pull the spring-loaded locking pin 138 downward, extending the spring portion, to release the locking pin 138 from a pin receiving aperture 141 of the hub 139. The user may then freely horizontally pivot the pivotable member 104 and arm 106, which pivots the hub 139 thereon. Once in the desired horizontal position, the user may release the spring-loaded locking pin 138, where it will return upward (due to the recoil of the spring portion) and therefore insert into an aligned pin receiving aperture 141, thereby selectively securing the arm 106 in the desired position and preventing unwanted horizontal pivoting.

For example, once a user has stored a bike thereon in the second, upright position (FIGS. 2 & 9), the user may desire to horizontally pivot the arm 106 and bike 120 thereon to place the bike 120 adjacent to a wall. To do so, a user pulls the locking pin 138, pivots the bike 120 and arm 106 proximal to the wall (or other desired position), which likewise pivots the pivotable member 104, and then releases the locking pin 138 so it engages with an aligned pin receiving aperture 141, thereby locking the pivotable member 104, and therefore the arm 106 and bike 120 thereon, in the desired position.

In FIG. 5, in some embodiments, the wall bracket 102 is configured to couple to one or more E-track rails 140A, 140B, which are coupled to the wall. It will be appreciated that the E-track rails 140A, 140B allow for ease of mounting and placement of the bike rack 100 on the wall and for the ability to easily attach, detach, and move the bike rack 100. As shown, a plurality of racks 100 may be coupled to the E-track rails 140A-B.

Referring now to FIGS. 6-7, the bike rack 100, in some embodiments, may further comprise a lock 142 to prevent access to the bottom lag screw holding the bike rack 100 to the wall and thereby preventing unwanted removal of the bike rack 100 therefrom. As shown, the lock 142 passes through a bottom portion of the wall bracket 102, blocking access to the bottom lag screws (or other fasteners). It may also simply serve as a storage mechanism for the bike lock 142 as well. A user may store the bike 120 and the lock 142 on the bike rack 100, and then when removing the bike 120, the user may also remove the lock 142 to take with them to secure the bike 120 when in public.

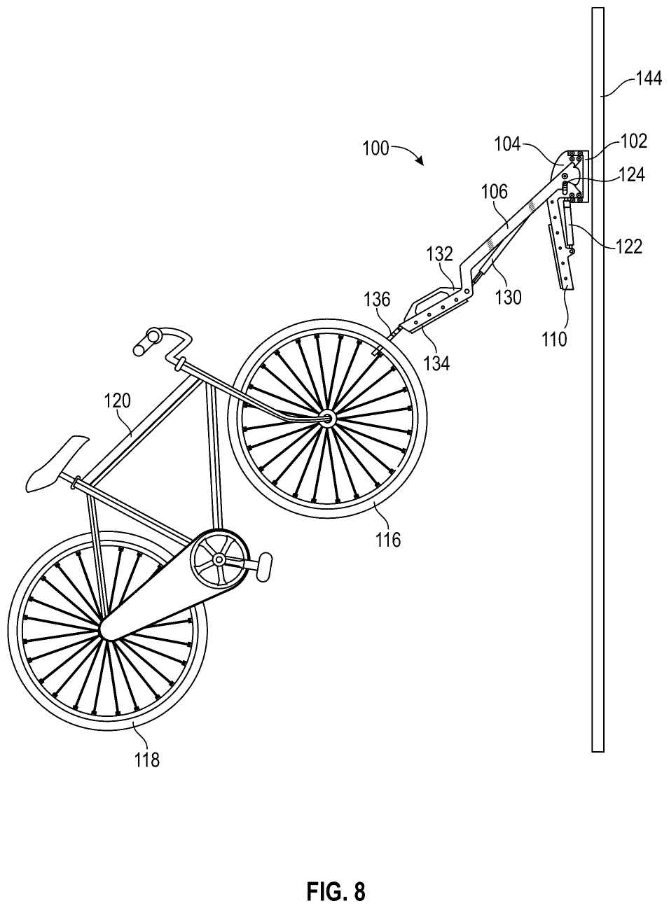

As illustrated in FIG. 8, in some methods of use, with the bike rack 100 mounted to a wall 144 (or other surfaces), the user will place the arm 106 in a first, down position, rotate the hook 136 to an outward position (e.g., extending longitudinally from the distal end of the arm 106) to receive the tire 116 (e.g., placing the bike in a wheelie so as to easily balance the bicycle while the tire 116 tire is received in the hook 136). With the tire 116 hooked, the user pulls backwards on the bike 120 (away from the wall 144), causing the cam pin 124 to move along the head 107 (cam mechanism), which allows the arm 106 to begin to raise vertically. Once the arm 106 reaches a vertical threshold, the gas spring 130 extends and begins to force the arm 106 upward, assisting the user with lifting the bike 120 on the arm 106. As shown in FIG. 9, once the bike 120 is fully lifted and the arm 106 is in the upright, second position, the first tire 116 abuts the second pad 134 while the second tire 118 abuts the first pad 114. The cam pin 124 is in the second notch 111, ensuring that the arm 106 and bike 120 thereon remain upright. The gas spring 130 and hydraulic damper 122 likewise aid in stabilizing the bike 120 in this position.

As long as the user can grasp the lower tire 118 positioned against the first pad 114, the bike 120 may be retrieved by simply pulling it down and outwardly, which compresses the hydraulic damper 122 as the cam pin 124 rides along the head 107 (the cam pin 124 and head 107 forming the cam mechanism), and likewise compresses the gas spring 130 to slowly lower the bike 120 until the cam pin 124 engages the first notch 109. The user can then remove the hook 136 from the tire 116 and bring the bike 120 to rest on the ground. It will be appreciated that the bike 120 can be mounted with either tire 116, 118 engaged with the hook 136. The bike rack 100 can stay in the downward position until the bike 120 needs to be stored again. It can also be pivoted horizontally to be parallel or proximal to the wall 144 and out of the way.

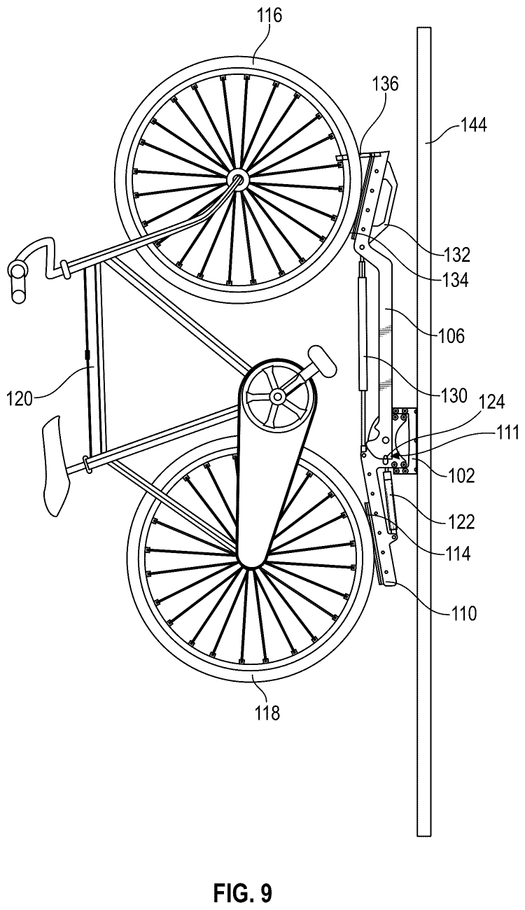

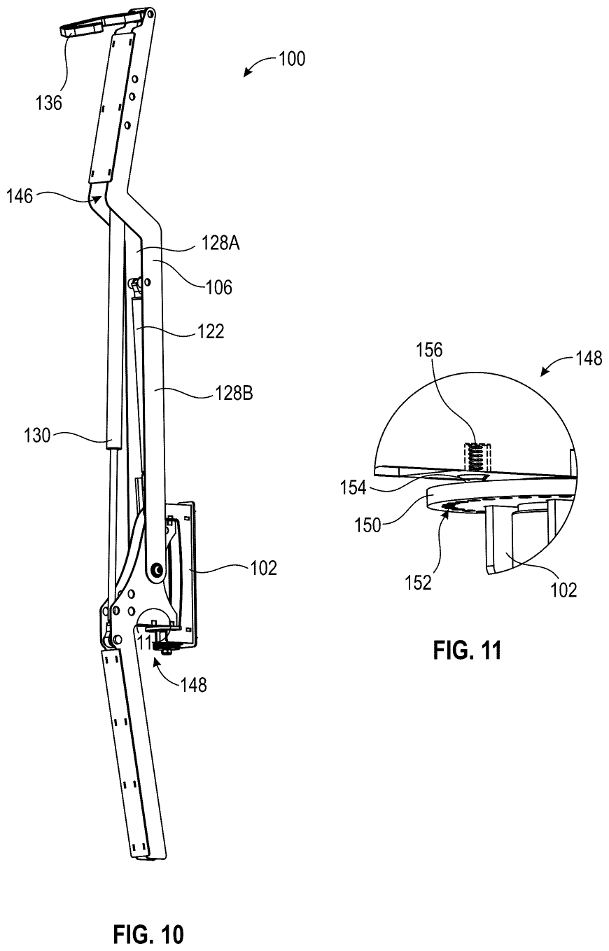

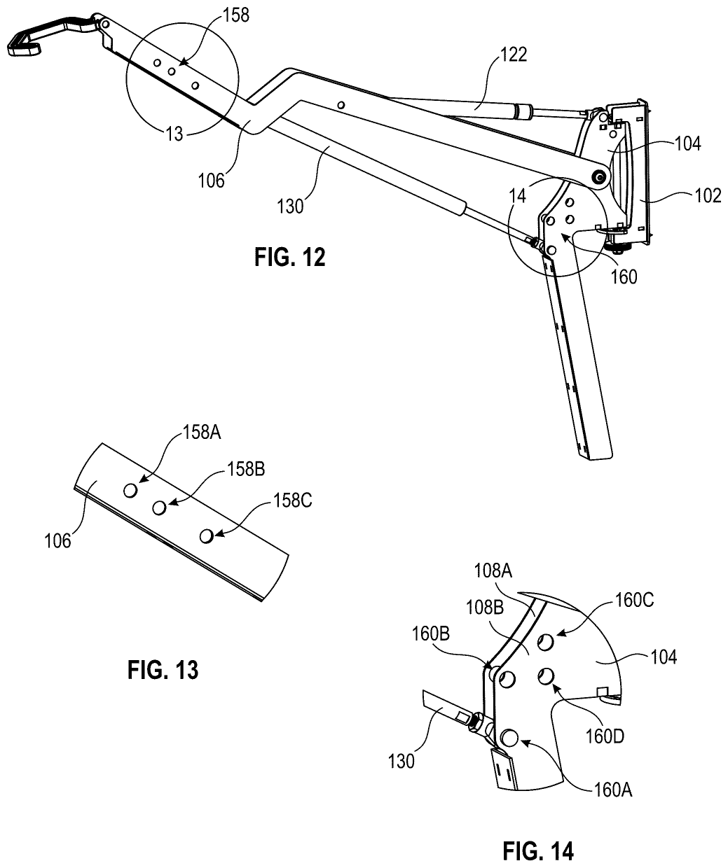

Referring to FIGS. 10-14, the bike rack 100 may include the damper 122 positioned and extending along the arm 106 instead of being coupled to the first tire member 110. In other words, the damper 122 may be coupled at a first end to the arm, and to the pivotable member 104 at a second end. As shown, because the arm 106 comprises a first arm panel 128A and a second arm panel 128B, a gap 146 is formed therebetween, allowing the damper 122 to be interposed and pass through the gap 146, as shown in FIGS. 10 and 12. The damper is beneficial for slowing the velocity of the arm 106 during upward pivoting motion. However, while a damper 122 has been shown and described, it may be omitted in some embodiments. For example, the gas spring 130 may be used alone. In some embodiments, the gas spring 130 may include a lock, allowing a user to effectively secure the arm 106 at a given height (e.g., first position or second position).

Further, as best seen in FIGS. 10-11, the hub 139 may be replaced by a detent mechanism 148. The detent mechanism 148 may comprise a disc 150, the disc 150 comprising a plurality of depressions 152 or other apertures configured to interact with a ball bearing 154 and detent spring 156 coupled and extending from the bottom end of the pivotable member 104. In other words, the detent spring 156 forces the ball bearing 154 downward, where it can be seated in a selected depression 152 of the disc 150 that is coupled to the wall bracket 102. When a user desires to pivot the arm 106 horizontally, the user need only exert enough horizontal force to cause the ball bearing 154 to compress the detent spring 156 as it exits the selected depression 152. A user may feel a “click” as the ball bearing 154 rotates through each depression 152. When the desired angle is reached, the ball bearing 154 remains seated in the aligned depression 152, prohibiting unwanted movement.

Further, and as best shown in FIGS. 12-14, the gas spring 130 may be positionable, on a first end, in relation to the arm 106 via a plurality of first mounting holes 158. In other words, a bolt or other fastener may be used to secure the first end (e.g., cylinder) of the gas spring 130 to the desired position via the plurality of first mounting holes 158. FIG. 13 illustrates three sets of mounting holes 158A-C, but it will be appreciated that more or fewer may be used.

Likewise, the opposite end (e.g., piston) may be selectively positionable in relation to the pivotable member 104 via a plurality of second mounting holes 160. For example, as best seen in FIG. 14, a user may select from a variety of second mounting holes 160A-D. As understood, each plate 108A-B comprises a hole that is aligned with the other, forming a set of mounting holes 160A-D. Depending on the mounting holes used, a user may alter the horizontal position (i.e., downward angle) of the arm 106 when lowered (the first position). The mounting holes also allow a user to alter the configuration depending on the weight of the bike. In one example of use, when using a lightweight bike with a higher downward angle when lowered (accommodating taller bikes), a user may couple the gas spring 130 to the first mounting hole 158A on a first end and may couple the second end to mounting hole 160C. If the user desires to have a lower downward angle (shorter bikes) with the lightweight bike, they may change to mounting holes 158B and 160D. For a heavier bike with a lower down angle, the user may use mounting holes 158C and 160A. For a heavier bike with a higher down angle, the user may use mounting holes 158B and 160B. It will be appreciated that these are only examples and different configurations may be used without departing herefrom.

To facilitate easily changing the position of the gas spring 130, the gas spring 130 is ideally fully-extended at the various mounting positions described above. As a result, the user need not overcome the spring force to remove or couple the gas spring 130 between the various mounting positions.

Additionally, it will be appreciated from FIGS. 10-14 that a cam mechanism is not required. In other words, the arm 106 may not have a head 107 configuration. Instead, the gas spring 130 and/or the damper 122 aid in maintaining the position of the arm in the desired position.

As appreciated, the bike rack 100 disclosed herein solves the need for a bicycle storage solution that not only maximizes space efficiency, but also ensures ease of access and stability. The bike rack 100 accommodate various storage space restrictions, provide multiple directions and positions for storing bicycles, and is safe and user-friendly. This significantly enhances the usability of storage areas, particularly in environments where space is at a premium and safety is a concern. As a result, the bike 120 can be quickly and easily stored above shoulder and head height, freeing up space, without the need for step stools or ladders, solving the problems in the art.

It will be appreciated that systems and methods according to certain embodiments of the present disclosure may include, incorporate, or otherwise comprise properties or features (e.g., components, members, elements, parts, and/or portions) described in other embodiments. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment unless so stated. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

Exemplary embodiments are described above. No element, act, or instruction used in this description should be construed as important, necessary, critical, or essential unless explicitly described as such. Although only a few of the exemplary embodiments have been described in detail herein, those skilled in the art will readily appreciate that many modifications are possible in these exemplary embodiments without materially departing from the novel teachings and advantages herein. Accordingly, all such modifications are intended to be included within the scope of this invention.

What is claimed is:

1. A wall-mounted bicycle rack, comprising:
a wall bracket;
a pivotable member coupled to the wall bracket, the pivotable member configured to pivot horizontally in relation to the wall bracket;
an arm coupled to the pivotable member, the arm configured to pivot vertically in relation to the pivotable member;
a gas spring coupled to the arm; and
a hook extending from a distal end of the arm.

2. The wall-mounted bicycle rack of claim 1, wherein the pivotable member comprises a first tire member extending downwardly from a first portion, and a hydraulic damper interposed between the first tire member and a cam pin passing through the pivotable member.

3. The wall-mounted bicycle rack of claim 1, wherein the arm comprises a gas spring coupled to the pivotable member on a first end and the arm on a second end.

4. The wall-mounted bicycle rack of claim 1, wherein the arm comprises a head, the head configured to interact with a pin to form a cam mechanism.

5. The wall-mounted bicycle rack of claim 1, wherein the pivotable member comprises a first pad configured to engage a first tire and the arm comprises a second pad configured to engage a second tire.

6. The wall-mounted bicycle rack of claim 1, wherein the pivotable member comprises a hub having a plurality of pin receiving apertures and a spring-loaded locking pin configured to selectively engage a pin receiving aperture of the plurality of pin receiving apertures.

7. The wall-mounted bicycle rack of claim 1, further comprising a detent mechanism configured to horizontally position the arm and pivotable member.

8. The wall-mounted bicycle rack of claim 7, wherein the detent mechanism comprises a disc coupled to the wall bracket, and a spring and ball bearing coupled to the pivotable member, the ball bearing configured to selectively engage one or more depressions in the disc.

9. The wall-mounted bicycle rack of claim 1, wherein the wall bracket is configured to couple to a plurality of E-tracks.

10. The wall-mounted bicycle rack of claim 1, wherein the wall bracket further comprises a lock configured to block at least one fastener securing the wall bracket to a wall.

11. The wall-mounted bicycle rack of claim 1, wherein in a first position, the arm extends downward with a pin in a first notch of a head of the arm, and in a second position, the arm extends upward with the pin in a second notch of the head of the arm.

12. A wall-mounted bicycle rack, comprising:
a wall bracket;
a pivotable member coupled to the wall bracket, the pivotable member comprising a first tire member extending downwardly;
a hydraulic damper coupled to the pivotable member;
an arm coupled to the pivotable member via a pin, the arm configured to pivot vertically on the pin in relation to the pivotable member;
a gas spring coupling the arm to the pivotable member; and
a hook extending from a distal end of the arm.

13. The wall-mounted bicycle rack of claim 12, wherein the arm comprises a head, the head configured to interact with a cam pin to form a cam mechanism.

14. The wall-mounted bicycle rack of claim 12, wherein the pivotable member comprises a first pad configured to engage a first tire and the arm comprises a second pad configured to engage a second tire.

15. The wall-mounted bicycle rack of claim 12, further comprising a hub comprising a plurality of pin receiving apertures and a spring-loaded locking pin configured to selectively engage a pin receiving aperture of the plurality of pin receiving apertures.

16. The wall-mounted bicycle rack of claim 12, wherein the wall bracket is configured to couple to a plurality of E-tracks.

17. The wall-mounted bicycle rack of claim 12, wherein the wall bracket further comprises a lock configured to block at least one fastener securing the wall bracket to a wall.

18. The wall-mounted bicycle rack of claim 12, wherein in a first position, the arm extends downward with a cam pin in a first notch of a head of the arm, and in a second position, the arm extends upwardly with the cam pin in a second notch of the head of the arm.

19. A method of using a wall-mounted bicycle rack, the method comprising:
mounting a wall bracket to a wall, the wall bracket coupled to a pivotable member, the pivotable member coupled to an arm;
wherein when in a first position, the arm extends downwardly in a bike receiving position and a user couples a tire of a bicycle to a hook extending from the arm;
the user then pulls rearwardly on the bicycle, while lifting upwardly, wherein the arm proceeds to a second position extending upwardly; and
a second tire resting on a first tire member.

20. The method of claim 19, wherein a user may alter the configuration of a gas spring to support differing weights of the bicycle and to determine a downward angle of the arm.
